(19) United States
(12) Patent Application Publication
(10) Pub. No.: US 2021/0291420 A1
(43) Pub. Date: Sep. 23, 2021

(54) HOT RUNNER DEVICE

(71) Applicant: EWIKON HEISSKANALSYSTEME GMBH, Frankenberg (DE)

(72) Inventors: Stefan EIMEKE, Frankenberg (DE); Peter BRAUN, Hungen (DE); Sebastian BROCKHAUS, Frankenberg (DE)

(21) Appl. No.: 17/266,231

(22) PCT Filed: Aug. 1, 2019
(86) PCT No.: PCT/EP2019/070754

§ 371 Date: Feb. 5, 2021

(30) Foreign Application Priority Data
Aug. 6, 2018 (DE) 10 2018 119 011.5

(51) Int. Cl. B29C 45/77; B29C 45/78

(52) U.S. Cl. CPC B29C 45/77; B29C 45/78; B29C 45/2725; B29C 2945/7604; B29C 2945/76006

(57) ABSTRACT

A hot runner device for an injection molding machine, wherein the hot runner device has at least one hot runner system, and at least one sensor, actuator and/or initiator which can be connected to a control and regulating device via one or more signal and/or data paths, in particular lines, wherein process data and/or process signals can be transmitted via the one or more signal and/or data lines, characterized in that the hot runner device further comprises a data acquisition and backup device which is designed at least for acquiring and storing part or all of the process data and/or signals acquired on the hot runner system during operation of the injection molding machine and which is a functionally integral component of the hot runner device.

### CROSS-REFERENCE TO RELATED APPLICATIONS

This application is a U.S. nationalization under 35 U.S.C. § 371 of International Application No. International Application No. PCT/EP2019/070754, filed 1 Aug. 2019, which claims priority to German Patent Application No. 10 2018 119 011.5, filed 6 Aug. 2018. The disclosures set forth in the referenced applications are incorporated herein by reference in their entireties.

### BACKGROUND AND SUMMARY OF THE DISCLOSURE

The present disclosure is directed to a hot runner device for an injection molding machine.

A hot runner device forms part of an injection molding machine which includes at least one plasticizing unit, which can, for example, be embodied as an extruder, and an openable and reclosable mold.

The mold has a first mold half and a second mold half. A heated hot runner system is installed in one half of the mold. The task of the hot runner system is to direct pressurized melt at a temperature above the glass transition or crystalline melting temperature through a manifold and nozzle system into one or more cavities of the mold. It can have as components a nozzle, a manifold and a sprue bush. In embodiments, it may include further components.

A hot runner device according to the disclosure has such a hot runner system for the passage of hot melt and also has electrical and/or electronic components which can be connected via a control and regulating device of the hot runner device to a central superordinate control and regulating device of the injection molding machine. The control and regulating device may control and/or regulate the entire injection molding process. The electrical and/or electronic components of the hot runner device include one or more sensors. In addition, these components usually include at least one temperature control loop, consisting of at least one heater and at least one temperature detector or sensor.

In the hot runner system of the hot runner device, the nozzle, manifold and sprue bush components are tempered by means of the heaters, wherein heating zones are formed. Each individual heating zone can be controlled separately. For this purpose, the temperatures per heating zone are measured using a suitable temperature measurement method (e.g. thermal element and/or thermocouple) and then serve as input or control variable for the control and/or regulating device of the hot runner device.

Within the mold half containing the hot runner system and its associated components—i.e. hot runner technology (here also referred to as hot runner device)—the connecting cables of the heaters and the thermocouple are brought together in a wiring box to form at least one plug. Using additional plugs and cables, the hot runner device is connected to the control device of the hot runner device.

As regards the technological background, DE112008001188 and DE 102013012914 should be mentioned. DE112008001188 discloses an injection molding machine having a control and regulating device comprising a memory device connected to a hot runner manifold and storing information for transmitting process data and signals to the control and/or regulating device of the injection molding machine.

DE 102013012914 describes a first control device that receives signals from a hot runner system and forwards them to a higher-level second control device.

It would be desirable to further optimize the prior art in order to achieve improved monitoring of the operation of the machine.

The present disclosure is directed to a hot runner device for an injection molding machine, wherein the hot runner device has at least one hot runner system and at least one sensor, actuator and/or initiator which can be connected to a control and regulating device via one or more signal and/or data paths, in particular lines, wherein process data and/or process signals can be transmitted via the one or more signal and/or data paths, wherein the hot runner device further has a data acquisition and securing device which is connected to the at least one signal and/or data path, is designed at least for acquiring and storing part or all of the process data and/or signals acquired on the hot runner system during operation of the injection molding machine, and is a functionally integral component of the hot runner device.

This makes it possible to store process data of the operating status of the hot runner device directly on the hot runner device, independent of the function and operation of the control and/or regulating device of the hot runner device. It is also conceivable to store this process data over a longer period or even over the entire lifetime of the hot runner device, wherein it is also conceivable to relocate the process data from time to time to another location and store it further, e.g. in a data cloud. This also makes it possible to define a permanent and fixed functional assignment of the stored process data to the hot runner device over the entire hot runner life cycle.

According to the prior art, however, process data on the operating status of the hot runner device was stored on a device directly assigned to the hot runner device. In addition, there was often no permanent and fixed assignment of the control and/or regulating device to the hot runner device over the entire hot runner life cycle. A separate unit was missing which directly and exclusively stores and evaluates process data via the hot runner system.

According to the present disclosure, the control and regulating device is the control and regulating device of the hot runner device. The control and regulating device may be connected to or be in operation with another central, higher-level control and regulating device of the injection molding machine, with which data and/or signals can, in embodiments, be exchanged bidirectionally.

A variant may provide in a simple manner that the one or more data paths is/are designed as electrical or optical lines or wireless paths and that the data acquisition and securing device is/are linked or connected to those electrical and/or optical lines or paths in order to enable the data acquisition and securing device to pick up the necessary signals and information which it then stores as process data.

There are various alternatives with regard to the exact design or circuit implementation. In particular, it may be advantageously provided that the data acquisition and securing device has at least one measured value acquisition device connected to the at least one sensor, actuator and/or initiator and at least one memory and analysis device connected to the measured value acquisition device. In this way, the two tasks of measured value acquisition and parameter acquisition on the one hand and storage on the other can be functionally well separated and realized.

According to an embodiment, it may be provided that the hot runner system has at least one nozzle, at least one manifold and at least one sprue bush as mechanically constructive components.

According to an embodiment, it may be provided that the data acquisition and data backup device of the hot runner device is designed to record or acquire, store and/or analyze process data directly from the hot runner system independently of the control and regulating device, in particular the hot runner device, and also preferably independently of the higher-level control and regulating device of the injection molding machine.

The memory and analysis device may have its own computer unit, which has a microprocessor unit and a data memory.

The memory and analysis device may also be divided into two functional devices, i.e. a storage device and an analysis device. This also falls under the concept of memory and analysis device.

For example, it is conceivable to store the captured data only directly or in parallel directly in the data cloud and, if necessary, to analyze it there or after a new download. In this case, the data cloud may assume the functions of the data backup device or the role of the memory device of the memory and analysis device. Then only one interface is required for bidirectional transmission into/from the cloud. It can also be provided that the hot runner device 14 has a code/tag/IP address so that the data in the cloud can be uniquely assigned to it. The analysis device can—in the case of data storage in the data cloud—be provided directly on the hot runner system or optionally elsewhere. There may also be a computer unit directly attached to the measured value acquisition device which is designed to allow storage and/or analysis of the data in the data cloud.

It is also advantageous if the data is stored in a non-volatile memory in such a way that the process data can be read out again later even after a power failure.

Claim 15 further provides that process data collected at time intervals with the measured value acquisition unit shall be easily stored in the memory and analysis device. Optionally, it can be advantageously provided that an analysis of the process data takes place in the memory and analysis device.

The memory and analysis device can store process data such as temperature data and/or pressure data and/or cycle data and/or process data on needle positions, speeds and strokes.

A hot runner device according to the present disclosure is explained herein in more detail with reference to the drawings by using embodiment examples. The invention is not limited to the embodiment examples described above but can also be realized in other ways falling within the scope of the appended claims.

### BRIEF DESCRIPTION OF THE DRAWINGS

FIG. 1 shows a schematic representation of an injection molding machine equipped with a hot runner device according to the present disclosure;

FIG. 2 shows in a) a schematic representation of a measured value acquisition unit, in b) a memory and analysis unit; and

FIG. 3 shows a schematic block diagram of a hot runner device.

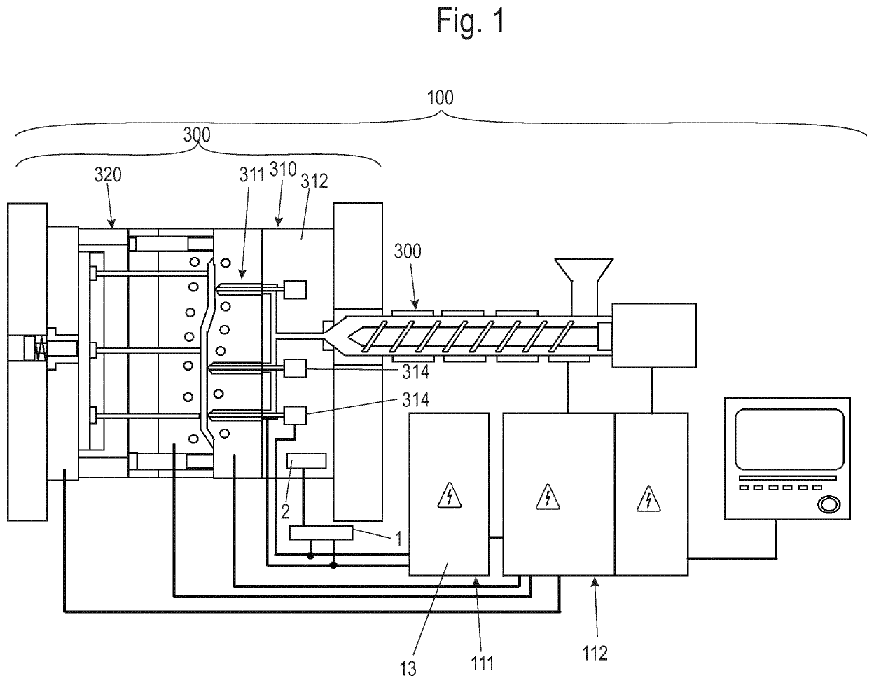

FIG. 1 shows a schematic representation of an injection molding machine 100, which has as components a plasticizing unit 200 for plasticizing melt—which can be designed, for example, as an extruder—and an openable and closable mold 300.

Mold 300 has two mold halves 310 and 320. The mold half 310 is here also synonymously referred to as hot runner system 11 (see FIG. 3) or comprises one of these.

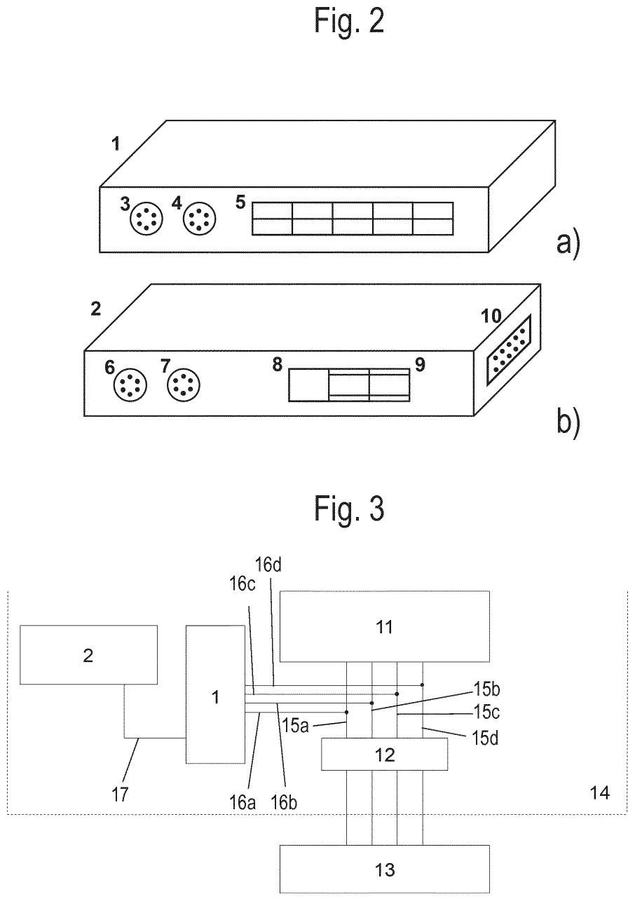

The hot runner system 11 is by definition part of a hot runner device 14. The hot runner device comprises the hot runner system 11 as well as electrical and/or electronic components (see also FIGS. 2a, b and 3).

The hot runner system 11 has—as explained at the outset with reference to the prior art—the object of directing pressurized melt at a temperature above the glass transition or crystallite melting temperature through a manifold and nozzle system (here FIG. 1) into one or more cavities of the mold. It can have as components at least one nozzle 311, at least one manifold (integrated in frame plate 312) and at least one sprue bush (integrated in frame plate 312) as well as possibly further machine elements or components.

The hot runner device 14 with the hot runner system 11 also has electrical and/or electronic components, which are connected here to a higher-level control and regulating device 13 of the hot runner device 14, which can control and/or regulate all hot runner parameters (e.g. temperatures) and/or the entire injection molding process. The control and regulating device is symbolically represented here by a control cabinet 111. In addition, there is a further switch cabinet 112, which can contain further components of the machine such as power supply units etc. Among other things, the control cabinet 112 also contains a further central control and regulating device for the injection molding machine, wherein the latter control and regulating device of the injection molding machine can exchange data with the control and regulating device 13 of the hot runner device 14 for hot runner control.

In the hot runner system 11 of the hot runner device 14, the components nozzles 311, manifold (integrated in frame plate 312) and sprue bush(es) (integrated in frame plate 312) are tempered by means of heaters, wherein heating zones are formed. Each individual heating zone is regulated separately. For this purpose, the temperatures per heating zone are measured using a suitable temperature measurement method (e.g. thermal element and/or thermocouple 313) and then serve as input or control variable for the control and/or regulating device 13 of the hot runner device 14.

Needle drives 314 for the nozzles 311 can also be integrated in the hot runner system 11 of the hot runner device 14. Each individual needle drive 314 is controlled separately, wherein the needle drive transmits an electrical quantity to the control and/or regulating device 13 of the hot runner device 14.

As a rule, within the mold half which contains the hot runner system and its associated components—i.e. preferably the complete hot runner technology (the so-called hot side, here also called hot runner device)—the connection cables of the heaters and the thermocouple are connected in a wiring box to at least one connector 12 (see also FIG. 2).

With the aid of this plug 12 as well as any other corresponding plug and cable, the hot runner device 14 is connected to the higher-level control and regulating device 13 of the hot runner device 14.

In addition, the hot runner device 14—according to the invention—has at least one data acquisition and data backup device which is directly at least functionally associated with it. This is provided in addition to the higher-level control and regulating device 13 of the hot runner device 14 and is functionally independent of it. It cannot therefore be connected thereto. The data acquisition and data backup device can also be assigned directly to the hot runner device 14.

This data acquisition and data backup device here has a measured value acquisition device 1 and a memory and analysis device 2 (see FIGS. 1 and 2).

These two devices are designed as two structurally separate boxes, which is advantageous, but not mandatory. The measured value acquisition device 1 and the memory and analysis device 2 can also be designed as an integrated box.

The hot runner device 14 also has various lines or cables 15a, b, c, d; 16a, b, c, d and at least one plug as external interface 12 (see FIGS. 1, 2a, b and 3).

In particular, the higher-level control device 13 of the hot runner device 14 can be connected to interface 12 and is also connected during operation.

In FIG. 3, lines 15a, b, c, d, . . . . are shown. These lines 15a, b, c, d, . . . symbolize one or more signal and/or data path(s), in particular an electrical or optical or wireless connection between sensors, actuators and/or initiators and the like of the hot runner system 11 on the one hand and here the interface 12 on the other hand.

This means that the sensors, actuators and/or initiators of the hot runner system 11 are connected directly via interface 12 to the higher-level control device 13 of the hot runner device. In addition, it is provided that the measured value acquisition device 1 is also connected to the sensors, actuators and/or initiators of the hot runner system, in particular for monitoring at least one process parameter of the injection molding process. For example, the measured value acquisition device 1 can be connected to the sensors, actuators and/or initiators via branch lines 16a, 16b, 16c, 16d on line(s) 15a, b, c, d or cables or by other means, e.g. wireless.

The data acquisition and data backup device of the hot runner device is designed to record, acquire, store and/or analyze process data directly from the hot runner system 11 independently of the higher-level control device 13 of the hot runner device 14. For this purpose, the data acquisition and backup device comprises at least the components measured value acquisition device 1 and the memory and analysis device 2. In particular, the latter device may independently comprise a computer unit which may comprise a microprocessor unit and a data memory.

With the measured value acquisition device 1, signals and process data are recorded during operation, in particular operating process signals and data of the hot runner system 11 and/or measured values from the hot runner system 11, which can thus be easily tapped within the hot side from the lines or cables 15a-d (e.g. thermocouple cables and/or power cables for the heaters), for example, which are to be provided anyway. No additional installations at the thermocouples, for example, are necessary to collect the data in the data acquisition and backup device. The signals are picked up at the existing connecting cables and are sufficient for acquisition and monitoring.

These process data and measured values are then transmitted to the memory and analysis device 2, where they are stored and can there optionally be processed further. For this purpose, the memory and analysis device 2 may be equipped with a computer program that performs the data storage and, if necessary, also analyzes the process data, e.g. in order to detect and, if necessary, display faults in the operation of the hot runner device 14. The corresponding process data are thus stored in an element or medium—the memory and analysis device 2—which is functionally directly attributable to the hot runner device 14.

Preferably, this storage in a non-volatile memory takes place in such a way that the process data can be read out again later even after a power failure.

In this way it is possible to store process data directly on the hot runner device 14, which reflect the process flow, so that they can be retrieved again, for example after a malfunction, independently of any additional storage on the central control and regulating unit 112, 113. In addition, the process flow can be recorded over the entire life cycle, even if the hot runner device 14 is used on different injection molding machines and/or is controlled and/or regulated by different control and regulating devices. The local assignment of the data acquisition and backup device to the hot runner device 14 enables all process data to be acquired independently of the injection molding machine and the control technology.

The measured value acquisition device 1 can be equipped in a variant with at least one analog input 5—in particular a thermocouple measuring input—as well as with at least one analog/digital converter and at least one measuring amplifier. In this way, at least one measured value can be recorded with an appropriate sensor and converted into at least one digital value. The measured value (e.g. a voltage signal or a current intensity signal) is tapped directly at the hot runner system 11 on lines already provided in accordance with the prior art, e.g. for the thermocouples located in nozzles, manifolds and sprue bushes, and fed to the measured value recording device 1.

This measured value acquisition device 1 can also have both an input interface 3 and an output interface 4 for data transmission. It is also possible to connect several measured value acquisition devices 1 in series in order to be able to acquire a large number of process data.

The measured value acquisition device 1 may be connected to the memory and analysis device 2 via a cable 17. In this device, the incoming process data are permanently stored in the intended internal memory, in particular at regular intervals (e.g. every 10 seconds).

The stored process data can preferably be accessed via various interfaces 8, 9 (e.g. USB, WLAN, Ethernet, Bluetooth). These can be intelligently visualized and evaluated in different ways.

In particular, the memory and analysis device 2 may also be designed to give an alarm in the event of deviations from pre-determined values. This can include the transmission of warnings in various forms (for example, by mail or system information) to different recipients.

Machine process data or analyses can be displayed on a display unit 113 of the injection molding machine. These machine process data are transmitted from the injection molding machine control 112 to the display unit 113. In the event of a malfunction, the memory and analysis device 2 can be used to compare the process data of the hot runner system with the machine process data of the injection molding machine controller, which also processes the data of the control and regulating device 13. In this way, it is possible to determine whether the process data from the hot runner deviates from the machine process data. From this comparison it can be determined whether the fault is in the hot runner device 14 or whether the fault is in the control and regulating device 13 or in the injection molding machine control 112.

The memory and analysis device 2 can have further interfaces, for example one or more of the following interfaces appeared to be useful:
one power supply connection 6,
an interface 7 for coupling with the measured value acquisition device 1,
an Ethernet connection 8,
one USB port 9,
a digital input 10 to receive signals from the injection molding machine via an optional line (not shown here).
WLAN and/or Bluetooth for wireless connection

The data acquisition and data backup device—in particular its memory and analysis device 2—is a direct functional component of the hot runner device 14 and independent of other connected devices such as a control and regulating device 13 of the hot runner device 14. This offers the advantage of being able to draw unbiased conclusions about the process in the entire hot runner system 11. Such a control and regulating device for the injection molding machine is additionally provided on this machine.

It is also conceivable to acquire and store control signals from the central control and/or regulating device 112 of the injection molding machine to the hot runner system 11 or to tap the process data on the cable between connector 12 and the control and/or regulating device 13.

One or more of the following options can also advantageously be realized:
Measurement of pressures (nozzle, manifold, sprue bush, drive pressures oil/air) by means of suitable sensors,
measurement of a cycle number, and/or
measurement of needle positions, speeds and strokes
measurement of forces of load cells installed in the hot runner device
positioning the measured value acquisition device 1 in a wiring box or outside the wiring box;
positioning the memory and analysis device 2 directly on the hot side or directly on the wiring box;
providing the memory and analysis device 2 with an input for receiving process data from an injection molding machine;
outputting a signal to the memory and analysis device 2 via one or more interfaces (e.g. Ethernet, USB, WLAN, Bluetooth);

1. A hot runner device for an injection molding machine, wherein the hot runner device has at least one hot runner system, and at least one sensor, actuator and/or initiator which can be connected to a higher-level control and regulating device via one or more signal and/or data lines, wherein process data and/or process signals are transmittable via the one or more signal and/or data lines, wherein the hot runner device further comprises a data acquisition and backup device which is designed at least for acquiring and storing part or all of the process data and/or signals acquired on the hot runner system during operation of the injection molding machine and which is a functionally integral component of the hot runner device; and wherein the data acquisition and backup device has at least one measured value acquisition device connected to the at least one sensor, actuator and/or initiator and at least one memory and analysis device connected to the measured value acquisition device, wherein the memory and analysis device has its own computer unit which has a microprocessor unit and a data memory and wherein the data acquisition and data backup device of the hot runner device is designed, independently of the control and regulating device of the hot runner device, to acquire or record, store, and/or analyze process data and/or process signals directly from the hot runner system.

2. The hot runner device according to claim 1, characterized in that the control and regulating device is the control and regulating device of the hot runner device, and in that said device can be connected to a further, central, higher-level control and regulating device of the injection molding machine.

3. The hot runner device according to claim 1, characterized in that one or more data lines is/are constructed as electrical or optical lines or wireless, and in that the data acquisition and backup device is/are attached or connected to these electrical and/or optical lines or paths.

4. (canceled)

5. The hot runner device according to claim 1, characterized in that the hot runner system includes at least one nozzle, at least one manifold and at least one sprue bush.

6. (canceled)

7. The hot runner device according to claim 1, wherein the data acquisition and data backup device taps the process data and/or process signals from the signal and/or data lines, before the process data and/or process signals are processed in the control and regulating device of the hot runner device.

8. (canceled)

9. The hot runner device according to claim 1, wherein the storage in a non-volatile memory takes place in such a way that the process data can be read out again later even after a power failure.

10. The hot runner device according to claim 1, wherein the measured value recording device has an input interface and an output interface for data transmission.

11. The hot runner device according to claim 1, wherein the memory and analysis device has one or more interfaces for external access to the stored process data.

12. The hot runner device according to claim 1, wherein the memory and analysis device is designed to trigger an alarm in the event of deviations from predetermined values.

13. The hot runner device according to claim 1, wherein the memory and analysis device has one or more further interfaces to which a voltage supply connection and/or an interface for coupling to the measured value recording device belong.

14. An injection molding machine having a control and/or regulating device and at least one hot runner device according to claim 1.

15. A method for acquiring process data of a hot runner device according to claim 1, wherein process data and/or process signals acquired at time intervals with the measured value acquisition unit are stored in the memory and analysis device.

16. The method according to claim 15, wherein an analysis of the process data takes place in the memory and analysis device.

17. The method according to claim 15, wherein the data is stored in a non-volatile data memory in such a way that the process data can be read out again later even after a power failure.

18. The method according to claim 15, wherein the incoming process data are stored in the data memory in predetermined regular time intervals in the memory and analysis device.

19. The method according to claim 15, wherein temperature data and/or pressure data and/or cycle data and/or process data relating to needle positions, speeds and strokes and/or force data are stored in the memory and analysis device.
